(19) United States
(12) Patent Application Publication
(10) Pub. No.: US 2002/0163678 A1
(43) Pub. Date: Nov. 7, 2002

(54) Method and apparatus for producing a covert holographic image

(76) Inventors: Kenneth A. Haines, Aptos, CA (US); Debby L. Haines, Santa Cruz, CA (US)

Correspondence Address: Clark & Brody, Suite 600, 1750 K Street, NW, Washington, DC, 20006, US

(21) Appl. No.: 10/158,126

(22) Filed: May 31, 2002

Related U.S. Application Data
(63) Continuation of application No. 08/870,275, filed on Jun. 6, 1997.
(60) Provisional application No. 60/019,310, filed on Jun. 7, 1996.

(51) Int. Cl. G03H 1/00; B42D 15/00

(52) U.S. Cl. 359/2; 283/86; 359/10

(57) ABSTRACT

A hologram having a covert image is made by recording on the hologram an object beam that will reconstruct an unrecognizable, scrambled image. The scrambled image can be modified to form a recognizable image by passing the scrambled image through a plate overlying the hologram.

### TECHNICAL FIELD

This invention relates to the art of holography. In particular, the invention relates to a hologram having an image that is hidden in normal usage but is visible when viewed through an overlay plate.

### BACKGROUND

It is often desirable to provide a document with an image that is viewable only under certain circumstances. For example, a document, or a label for an article, may be provided with an image that is not viewable without the use of a particular element, such as an overlay plate. The overlay plate may be generally unavailable to unauthorized persons, or it may be a commonly available element. If the overlay plate is commonly available, the ability of this “covert” image to verify the authenticity of the document or label is predicated on the inability of a forger to recreate the particular covert image in the first place. Thus, even though the overlay plate is available, the covert image may be so complex that it presents the forger with so many variables that reproduction is effectively precluded.

In one example of a non-holographic covert image, a design is subjected to lenticular dissection and scrambled prior to recordation. The recorded image of the design is not capable of being viewed without the use of an overlay plate, which is a lenticular element. When viewed through the lenticular element, the document is verified when a clear image of the design is seen through the lenticular element. The recordation of the image requires selection of such factors as the particular design, object and image distances, aperture sizes, depth of focus, and the like. Because these cannot be easily determined by a forger, they effectively prevent duplication.

Holograms have been used as security devices by themselves because they are difficult to manufacture. Thus, forgers generally cannot manufacture documents having viewable holograms because they do not have the required sophisticated equipment. Some forgers, however, have developed methods for copying such security holograms in those instances where the reward is great enough. Thus, it has become desirable to add additional security features to holograms.

### SUMMARY OF THE INVENTION

In accordance with the invention, a hologram is provided with a pattern that reconstructs an image that is normally hidden but which can be viewed with the use of additional optical equipment. This covert image provides increased security because it requires recordation of a holographic image that is normally scrambled, which is quite difficult for a forger, and also because it requires the use of additional viewing equipment to produce a viewable image. The hologram may contain more than one of these covert images, and the covert images may be of the same object or different objects. Also, the covert images may be located anywhere on the hologram. The hologram may also contain one or more overt images, which are capable of being viewed without the additional optical equipment, in addition to the covert image or images. The overt images may be holographic, lithographic, or any other type of recording. When the covert and overt images are both holographic, the overt image serves as a security device in the same manner as do holograms in the prior art, and the covert image provides additional security.

In one embodiment of the invention, the covert image is viewable only with the use of an overlay plate that modifies both the reconstruction beam incident on the hologram and the reconstructed image beam reflected from the hologram. The overlay plate can be in any form, including, but not limited to, a lenticular lens. Such a lenticular lens would contain a plurality of contiguous, lenslets, each of which is an individual optical element that produces an individual image. The lenslets can be cylindrical, spherical, or of any other shape. While the overlay plate is preferably a phase plate, it may contain amplitude variations as well.

Holograms useful with this invention can be surface relief holograms, volume holograms, or any other type of hologram. As well, the reconstructed images may be on the hologram surface or off the surface.

In general, a hologram having the covert image contemplated by the invention requires holographic recording of an object beam that has been modified such that, upon illumination by an incident reconstruction beam that has passed through the overlay plate, it will reconstruct an image beam in reflection that will produce a visibly correct image after modification by the overlay plate. A preferred technique for recordation of such an object beam is the technique shown in U.S. Pat. No. 5,237,433 (Haines et al.). According to the processes described in that patent, a composite hologram is constructed by determining with computer techniques the rays incident on individual hologram elements. A plurality of such hologram elements is recorded to form a composite hologram that will reconstruct the desired image beam. Use of this technique to construct the covert image hologram of the invention allows the effect of the overlay plate to be mathematically expressed and the object beam modified to record the individual hologram elements that will reconstruct the desired wave front.

In one embodiment, the overlay plate is a sheet having smoothly varying phase changes such as a lenticular sheet having cylindrical lenslets. Such an overlay plate is particularly useful with holograms that are designed not to have vertical parallax. The dimensions of the sheet are preferably chosen such that one lenslet covers several hologram elements. In this embodiment, the primary effect of the lenticular sheet is to bend the rays of the reconstruction light beam incident on the hologram by an angle e as well as to bend the rays of the reconstructed image beam by the same angle. The magnitude of angle e is dependent on the position of the incident ray with respect to the curvature of the overlay plate, which means that the effect of the overlay plate on the hologram is a periodic function across the face of the plate.

In the embodiment where the overlay plate is a lenticular element, and the hologram is a composite hologram, each of the pixels for each of the composite hologram's elements is shifted in position by an amount determined by the effect of the lenticular plate. As noted above, the lenticular plate bends the light rays by an angle dependent on the position of the reconstructing ray with respect to the lenticular element, and the rays of the reconstructed image beam are bent by the same amount. Thus, when a lenticular element is used as the overlay plate, the pixels for each element are shifted during recordation to account for the effect of the lenticular plate.

In another embodiment, a physical object, a photograph, a transparency, or the like having the shape of the covert image is made. This object is then illuminated with an object beam, and a hologram is recorded in known manner. When a hologram having such a recorded image is illuminated with a reconstruction beam, the reconstructed image of the recorded object will be the scrambled form and not recognizable unless viewed through the overlay plate.

### BRIEF DESCRIPTION OF THE DRAWINGS

FIG. 1 is a side view of a hologram and an overlay plate showing reconstruction of a covert image.

FIG. 2 is a partial side view of a hologram showing recordation of an object beam containing a covert image.

FIG. 3 is a partial side view of a hologram and a lenticular overlay plate.

### DETAILED DESCRIPTION OF THE INVENTION

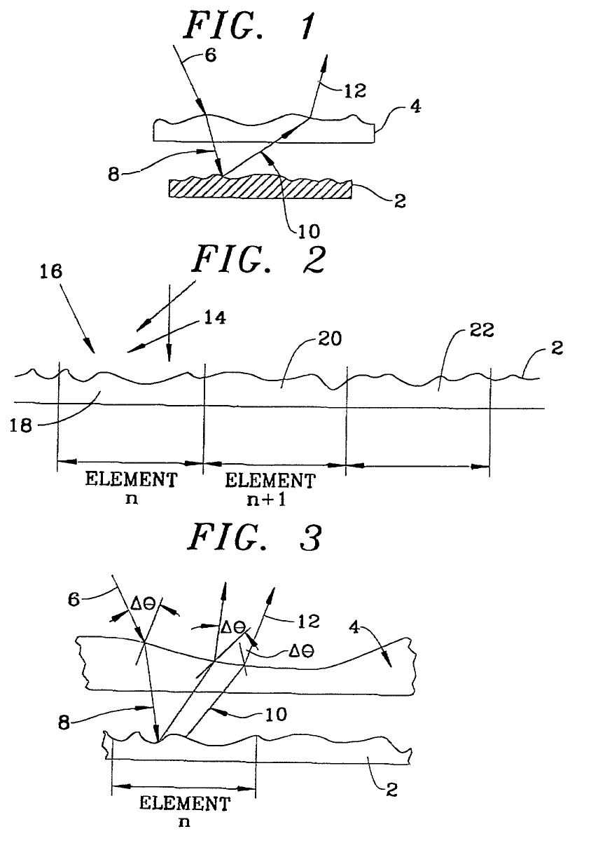

With reference to FIG. 1, a hologram 2 has an image recorded thereon that is capable of being viewed only when the hologram is illuminated and viewed through an overlay plate 4. Thus, an illumination beam 6 is incident on the overlay plate and is modified by passage through the plate to form a modified beam 8, which then illuminates the hologram 2. The hologram will diffract an image beam 10, which is subsequently modified by the overlay plate to form a modified image beam 12.

In accordance with the invention, the diffracted image beam that arises when the hologram 2 is illuminated by reference beam 6 is not recognizable by a user when viewed directly. When the hologram is illuminated by the modified beam 8, however, the hologram will generate an image beam that will be recognizable when viewed through the overlay plate. Thus, the pattern that is recorded on the hologram plate must be one that will generate an image beam carrying a recognizable image only when viewed through the overlay plate.

FIG. 2 illustrates one technique for recording the hologram 2. In accordance with this technique, a complex object beam 14 is generated by a computer. An object beam 14 is determined for each of a plurality of contiguous elements, such as those shown at 18, 20, and 22. The complex object beams are recorded on a hologram plate by interference with a reference beam 16. Each of the object beams is determined by constructing a window of pixels, each of which represents the intensity of a light ray extending from an object to the particular hologram element, the intensity of each particular pixel being calculated by the computer. The hologram is built up element-by-element by combining each object beam 14, created by directing light through a respective individual window, with a reference beam 16, until an entire composite hologram is formed.

Application of the above technique to the present invention requires selection of the particular object to be the subject of the convert image and then arrangement of the data making up the windows such that the desired object beam is obtained. As noted earlier, the desired object beam is one that will produce a reconstructed image that, when viewed through the overlay plate, is recognizable. The procedure for arranging the data will be explained with reference to FIG. 3.

FIG. 3 illustrates a lenticular overlay plate having cylindrical elements. Thus, only variations in the horizontal direction need be considered. The phase variation imposed on the illuminating beam 6 by the lenticular plate is preferably a smooth function of distance across the plate. The overlay plate will have two primary effects on the reconstruction process. First, for element “n” the plate will change the angle of the incoming reconstruction beam 6 by an angle ΔΘₙ, which will cause the hologram to be illuminated by modified beam 8 and will affect the position of that part of the reconstructed image. Second, the rays of the reconstructed image beam 10 that are diffracted from the hologram will be bent by passage through the overlay plate, also, by an angle ΔΘₙ. This latter effect will shift the apparent position of each piece of the image generated by the hologram by an amount dependent on the space between the overlay plate and the hologram and the location of the particular hologram element “n” with respect to the phase variations of the overlay plate. Thus, the effect of the overlay plate will be different for each of the elements of the hologram along the plate but will be a periodic function when the overlay plate is lenticular. While the effect of an overlay plate having a simple, periodic structure is relatively easily calculated, the effects can be calculated for an overlay plate having virtually any known structure.

Compensation for the effects of the overlay plate is achieved by moving the object points in the hologram. That is, the position of each point in the reconstructed image is moved to account for the effect of the overlay plate. This is accomplished in the preferred embodiment by adjusting the position of each data point, i.e., each of the pixels, within each of the hologram elements. The amount of the shift is determined by (1) determining the position across the lenticular lens for each of the elements, (2) determining the angle through which rays entering the lens at that location are rotated, (3) doubling the angle determined in the second step to account also for the tilt imposed on the reconstruction beam, and (4) using the calculation of the third step to determine the appropriate lateral shift for each pixel of the covert image. For example, a lenticular overlay plate having cylindrical lenses spaced (i.e., periods) by about 400μ may be used with a hologram having elements sized such that five elements fit beneath a cylindrical lens element. The position of each ray along the cylindrical lenses and its concomitant angle of refraction are easily determined, and the necessary displacement for each pixel in the window of pixels is then determined for the particular lens (e.g., an Fl lens) used to image the computer-generated window onto the hologram plate to form the hologram element. In this example, if the window of pixels is 200 pixels wide, each of the pixels in the window generating the hologram element centered at a distance of about 80μ from the center of the lens element will be shifted laterally by about 20 pixels.

The above procedure will produce a hologram that will reconstruct an image viewable through the overlay plate when the reconstruction beam also passes through the overlay plate. To ensure that the image is not recognizable (covert) when the overlay plate is not used, several parameters should be optimized. For example, the covert object distance should be relatively large, the period of the overlay plate should be moderate, and the spread angle should be relatively large. If the period is too large, however, the line structure of the covert image will be too obvious.

Also, the particular image itself and its relationship to the other images on the hologram will affect the ability of a user to detect the covert image.

Modifications within the scope of the appended claims will be apparent to those of skill in the art.

I claim:

1. A hologram having holographic pattern thereon for reconstructing a covert reconstructed image that is not recognizable by a user but which may be made recognizable by passing said reconstructed image through optical modifying means.

2. A hologram according to claim 1 wherein said holographic pattern is capable of reconstructing an overt image that is recognizable without passing through said modifying means.

3. A hologram according to claim 2 wherein said modifying means comprises a lenticular plate.

4. A hologram according to claim 3 in combination with said modifying means.

5. A hologram according to claim 2 wherein said holographic pattern comprises a surface relief pattern.

6. A hologram according to claim 2 wherein said holographic pattern comprises a volume hologram pattern.

7. A hologram according to claim 1 wherein said holographic pattern comprises a plurality of optically independent holographic elements.

8. A hologram according to claim 7 wherein each of said holographic elements comprises a pattern representing interference between a reference beam and an object beam produced by illumination of a computer generated pattern.

9. A method for making a hologram comprising the step of recording a holographic pattern for reconstructing a covert reconstructed image that is not recognizable by a user but which may be made recognizable by passing said reconstructed image through optical modifying means.

10. A method according to claim 9 wherein said step of recording comprises the step of recording on a holographic recording plate an object beam representing an unrecognizable object that can be made recognizable by modification with said optical modifying means.

11. A method according to claim 10 wherein said step of recording comprises the steps of defining a recognizable object, modifying the definition of said recognizable object in accordance with a modification function representing said modifying means to produce an unrecognizable object, and generating a modified object representing said unrecognizable object.

12. A method according to claim 11 wherein said step of generating a modified object comprises electronically generating said modified object.

13. A method according to claim 11 wherein said holographic recording plate is a surface relief recording plate.

14. A method according to claim 11 wherein said holographic plate is a volume hologram.

15. A method according to claim 12 wherein said holographic pattern is a composite pattern of optically independent holographic elements.
